(19) United States
(12) Patent Application Publication
(10) Pub. No.: US 2025/0050631 A1
(43) Pub. Date: Feb. 13, 2025

(54) METAL EFFECT PIGMENTS COATED WITH ADDITIVES FOR NANOMETALLOGRAPHY PRINTING

(71) Applicant: ECKART GmbH, Hartenstein (DE)

(72) Inventors: Oliver Bedford, Hartenstein (DE); Dieter Proelss, Hartenstein (DE); Oliver Struck, Hartenstein (DE); Michael Ostermeier, Hartenstein (DE)

(21) Appl. No.: 18/722,833

(22) PCT Filed: Dec. 21, 2022
(86) PCT No.: PCT/EP2022/087276

§ 371 Date: Jun. 21, 2024

(30) Foreign Application Priority Data
Dec. 22, 2021 (EP) 21216982.5

(51) Int. Cl. B41F 19/00; B41M 1/22

(52) U.S. Cl. CPC B41F 19/005; B41F 19/001; B41F 19/004; B41M 1/22

(57) ABSTRACT

The invention relates to a method of printing onto the surface of a substrate, which method comprises a. coating a donor surface with a monolayer of individual particles, b. treating the surface of the substrate to render the affinity of the particles to at least selected regions of the surface of the substrate greater than the affinity of the particles to the donor surface, and c. contacting the surface of the substrate with the donor surface to cause particles to transfer from the donor surface only to the treated selected regions of the surface of the substrate, thereby exposing regions of the donor surface from which particles are transferred to the corresponding regions on the substrate, and characterised in that at least 50 wt. % of the particles are flaky metal pigments comprising a flaky metallic substrate and a surface modification layer of the metallic substrate, wherein the surface modification layer has been made by a treatment of the metallic substrate surface by at least one of the modification substances from the group consisting of phosphate ester, phosphonic esters, phosphonic acids, phosphinate esters, organofunctional silanes, organofunctional titanates, organofunctional zirconates, organofunctional aluminates and mixtures thereof.

The present invention relates to a method for printing on a substrate and more in particular to a method capable of applying a layer having a metallic appearance to a substrate.

Various systems are known in the art to print a layer having a metallic appearance of a substrate such as paper or plastic film. These systems fall into two broad categories, viz. foil stamping or foil fusing. One of the main disadvantages of both methods is the large amount of foil that is wasted in these processes, since foil area that is not transferred to form the desired image on a substrate cannot be recovered for use in the same process. Since metal foils are expensive, these processes are relatively costly, as the foil can only be used once and only a small part of the metal is effectively transferred to the substrate.

In WO 2016/189515 A9 a new process is disclosed which enables the printing of a layer having a metallic appearance to a substrate in a much more cost-effective way without any waste of metal or metallized foil. In this process individual metal particles are transferred onto a substrate through a donor roll, wherein the metal particles on the donor roll are replenished in a repeating process. Although this process does not have all the disadvantages of the foil stamping or foil fusing process, it was found that the gloss of the metallic layer obtained through this process was not very high and/or showed degradation over time.

Surprisingly, a process was found that does not show the various disadvantages of the above described processes, in particular the process according to the present invention provides for the printing of a layer having a metallic appearance onto a substrate, where this layer has a high gloss level which does not show any degradation over time.

The process according to the present invention relates to a method of printing onto a surface of a substrate, which method comprises
a. Providing a donor surface
b. Passing the donor surface through a coating station from which the donor surface exits coated with individual particles, and
c. Repeatedly performing the steps of
   i. Treating the surface of the substrate to render the affinity of the particles to at least selected regions of the surface of the substrate greater than the affinity of the particles to the donor surface,
   ii. Contacting the surface of the substrate with the donor surface to cause particles to transfer from the donor surface only to the treated selected regions of the surface of the substrate, thereby exposing regions of the donor surface from which particles are transferred to the corresponding regions on the substrate, and
   iii. Thereby generating a plurality of individual particles adhered to the treated surface of the substrate
   iv. Returning the donor surface to the coating station to render the particle monolayer continuously in order to permit printing of a subsequent image on the surface of the substrate,
wherein at least 50 wt. % of the individual particles are metal pigments comprising a metallic substrate and a surface treatment of the metallic substrate, wherein the surface modification has been made by a treatment of the metallic substrate surface by at least one of the modification substances from the group consisting of phosphate esters, phosphonic esters, phosphonic acids, phosphinate esters, organofunctional silanes, organofunctional titanates, organofunctional zirconates, organofunctional aluminates, and mixtures thereof.

This method may further include a cleaning step, during which particles remaining on the donor surface after contacting the substrate are removed from the donor surface, so that prior to the next passage through the cleaning station the donor surface is substantially devoid of particles. Such cleaning step may be performed during each printing cycle or periodically, for instance in between print jobs, changes of particles and the like. A printing cycle corresponds to the time period in-between subsequent passing of a reference point on the donor surface through the coating station, such passage resulting from the donor surface being movable with respect to the coating station.

The donor surface coated with particles is used in a manner analogous to the foil used in foil imaging. However, unlike foil imaging, the damage caused to the continuity of the particle layer on the donor surface by each impression can be repaired by re-coating only the exposed regions of the donor surface from which the previously applied layer has been stripped by transfer to the selected regions of the substrate.

The reason that the particle layer on the donor surface can be repaired after each impression is that the particles are selected to adhere to the donor surface more strongly than they do to one another. This results in the applied layer being substantially a monolayer of individual particles.

Preferably, in step b the donor surface exits the coating station coated with a monolayer of particles. The term “monolayer” is used herein to describe a layer of particles on the donor surface in which at least 60% of the particles is in direct contact with the donor surface, in some embodiments from 70-100% of the particles is in direct contact with the donor surface, in a further embodiment from 85-100% of the particles is in direct contact with the donor surface. While some overlap may occur between particles contacting any such surface, the layer may be only one particle deep over a major proportion of the area of the surface. The monolayer herein is formed from the particles in sufficient contact with the donor surface and is therefore typically a single particle thick. Direct contact means that for the particle to remain attached to the donor surface at the exit of the coating station, e.g. following surplus extraction, burnishing, or any other like step.

To obtain a mirror-like of high gloss area on (selected parts of) the substrate, the selected surface should be sufficiently covered with the particles, which means that at least 70% of the selected surface is covered with the particles, or at least 80%, or at least 90% or at least 95% of the selected surface is covered with particles. The percentage of an area covered by particles out of a specific target surface can be assessed by numerous methods known to skilled persons, including by determination of optical density possibly in combination with the establishment of a calibration curve of known coverage points by measurement of reflected light, by measurement of transmitted light if the substrate is sufficiently transparent or by measurement of reflected light as the particles are reflective. A preferred method of determining the percentage area of a surface of interest covered by particles is as follows. Squared samples having 1 cm edges are cut from the surface being studied (e.g. from the donor surface or from the printed substrate). The samples are analyzed by microscopy (either laser confocal microscopy (Olympus®, LEXT OLS30ISU) or optical microscopy (Olympus® BX61 U-LH100-3)) at a magnification of up to ×100 (yielding a field of view of at least about 128.9 μm×128.6 μm). At least three representative images are captured in reflectance mode. The captured images were analyzed using ImageJ, a public domain Java image processing program developed by the National Institute of Health (NIH), USA. The images are displayed in 8-bit, gray scale, the program being instructed to propose a threshold value of reflectance differentiating between the reflective particles (lighter pixels) and the interstices that may exist between neighboring or adjacent particles (such voids appearing as darker pixels). A trained operator may adjust the proposed threshold value, if needed, but typically confirms it. The image analysis program then proceed to measure the amount of pixels representing the particles and the amount of pixels representing the uncovered areas of the intra-particle voids, from which the percent area of coverage can be readily calculated. Measurements done on the different image sections of the same sample are averaged. When the samples are printed on a transparent substrate (e.g. a translucent plastic foil), a similar analysis can be done in transmittance mode, the particles appearing as darker pixels and the voids as lighter ones. Results obtained by such methods, or by any substantially similar analytical techniques known to those of skill in the art, are referred to as optical surface coverage, which can be expressed in percent or as a ratio.

If printing is to take place on the entire surface of the substrate, the receptive layer, which preferably may be an adhesive, may be applied to the substrate during step i by a roller before it is pressed against the donor surface. Most preferably a receptive and/or adhesive layer is applied onto the substrate in step i.

Especially if printing is only to take place on selected regions of the substrate, on the other hand, then it is possible to apply the adhesive layer or receptive layer by any conventional printing method, for example by means of a die or printing plates, or by jetting the receptive layer onto the surface of the substrate. In other embodiments the receptive layer is applied to the substrate surface by an indirect printing method such as offset printing, screen printing, flexographic printing or gravure printing.

As a further option, it is possible to coat the entire surface of the substrate with an activatable receptive layer that is selectively rendered “tacky” by suitable activation means. Whether selectively applied or selectively activated, the receptive layer in such case forms a pattern constituting at least part of the image being printed on the substrate.

The term “tacky” is used herein only to indicate that the substrate surface, or any selected region thereof, has sufficient affinity to the particles to separate them from the donor surface and/or to retain them on the substrate, when the two are pressed one against the other at an impression station and it need not necessarily be tacky to the touch. To permit the printing of patterns in selected regions of the substrate, the affinity of the receptive layer, activated if needed, towards the particles needs to be greater than the affinity of the bare substrate to the particles. In the present context, a substrate is termed “bare” if lacking a receptive layer or lacking a suitably activated receptive layer, as the case may be. Though the bare substrate should for most purposes have substantially no affinity to the particles, to enable the selective affinity of the receptive layer, some residual affinity can be tolerated (e.g., if not visually detectable) or even desired for particular printing effects.

The receptive layer may, for instance, be activated by exposure to radiation (e.g., UV, IR and near IR) prior to being pressed against the donor surface. Other means of receptive layer activation include temperature, pressure, moisture (e.g., for rewettable adhesives) and even ultrasound, and such means of treating the receptive layer surface of a substrate can be combined to render tacky the compatible receptive layer.

Though the nature of the receptive layer being applied to the surface of the substrate may differ, among other things, from substrate to substrate, with the mode of application and/or the selected means of activation, such formulations are known in the art and need not be further detailed for an understanding of the present printing method and system. Briefly, thermoplastic, thermosetting or hot-melt polymers compatible with the intended substrate and displaying sufficient tackiness, relative affinity, to the envisioned particle, optionally upon activation, can be used for the implementation of the present disclosure. Preferably the receptive layer is selected so that it does not interfere with the desired printing effect (e.g., clear, transparent, and/or colorless).

A desired feature of the suitable adhesives relates to the relatively short time period required for activating the receptive layer, i.e. selectively changing the receptive layer from a non-tacky state to a tacky state, increasing the affinity of the selected region of the substrate so that it becomes sufficiently attached to the particles to separate them from the donor surface. Fast activation times enable the receptive layer to be used in high-speed printing. Adhesives suitable for implementation of the present disclosure are preferably capable of activation within a period of time no longer than the time it takes the substrate to travel from an activating station to the impression station.

In some embodiments, activation of the receptive layer can take place substantially instantaneously at the time of the impression. In other embodiments, the activation station or step may precede the impression, in which case the receptive layer can be activated within a time period of less than 10 seconds or 1 second, in particular in a time period of less than about 0.1 second and even less than 0.01 second. This time period is referred to herein as the receptive layer's “activation time.”

As already mentioned, a suitable receptive layer needs to have sufficient affinity with the particles to form the monolayer according to the present teachings. This affinity, which can be alternatively considered as an intimate contact between the two, needs to be sufficient to retain the particles on the surface of the receptive layer and can result from the respective physical and/or chemical properties of the layer and the particles. For instance, the receptive layer may have a hardness sufficiently high to provide for satisfactory print quality, but sufficiently low to permit the adhesion of the particles to the layer. Such optimum range can be seen as enabling the receptive layer to be “locally deformable” at the scale of the particles, so as to form sufficient contact. Such affinity or contact can be additionally increased by chemical bonding. For instance, the materials forming the receptive layer can be selected to have functional groups suitable to retain the particles by reversible bonding (supporting non-covalent electrostatic interactions, hydrogen bonds and Van der Waals interactions) or by covalent bonding. Likewise, the receptive layer needs be suitable to the intended printing substrate, all above considerations being known to the skilled person.

The receptive layer can have a wide range of thicknesses, depending for example on the printing substrate and/or on the desired printing effect. A relatively thick receptive layer can provide for an “embossing” aspect, the design being raised above the surface of the surrounding substrate. A relatively thin receptive layer can follow the contour of the surface of the printing substrate, and for instance for rough substrates enable a matte aspect. For glossy aspect, the thickness of the receptive layer is typically selected to mask the substrate roughness, so as to provide an even surface. For instance, for very smooth substrates, such as plastic films, the receptive layer may have a thickness of only a few tens of nanometers, for example of about 100 nm for a polyester film (for instance a polyethylene terephthalate (PET) foil) having a surface roughness of 50 nm, smoother PET films allowing to use even thinner receptive layers. Substrates having rougher surfaces in the micron, or tens of micron, range will benefit of a receptive layer having a thickness in the same size range or order of size range, if glossy effect, hence some levelling/masking of substrate roughness is desired. Therefore, depending on the substrate and/or desired effect, the receptive layer can have a thickness of at least 10 nm, or at least 50 nm, or at least 100 nm, or at least 500 nm or at least 1,000 nm. For effects that can be perceptible by tactile and/or visual detection, the receptive layer may even have a thickness of at least 1.2 micrometres (μm), at least 1.5 μm, at least 2 μm, at least 3 μm, at least 5 μm, at least 10 μm, at least 20 μm, at least 30 μm, at least 50 μm, or at least 100 μm. Though some effects and/or substrates (e.g. cardboard, carton, fabric, leather and the like) may require receptive layers having a thickness in the millimetre range, the thickness of the receptive layer typically does not exceed 800 micrometres (μm), being at most 600 μm, at most 500 μm, at most 300 μm, at most 250 μm, at most 200 μm, or at most 150 μm.

After printing has taken place, namely after the particles are transferred from the donor surface to the tacky regions of the treated substrate surface (i.e., the receptive layer) upon pressing, the substrate may be further processed, such as by application of heat and/or pressure, to fix or burnish the printed image and/or it may be coated with a varnish (e.g., colorless or colored, transparent, translucent, or opaque overcoat) to protect the printed surface and/or it may be overprinted with an ink of a different color (e.g., forming a foreground image). While some post-transfer steps may be performed on the entire surface of the printed substrate (e.g., further pressure), other steps may be applied only to selected parts thereof. For instance, a varnish may be selectively applied to parts of the image, for instance to the selected regions coated with the particles, optionally further imparting a coloring effect.

Any device suitable to perform any such post-transfer step can be referred to as a post-transfer device (e.g., a coating device, a burnishing device, a pressing device, a heating device, a curing device, and the like). Post-transfer devices may additionally include any finishing device conventionally used in printing systems (e.g., a laminating device, a cutting device, a trimming device, a punching device, an embossing device, a perforating device, a creasing device, a binding device, a folding device, and the like). Post-transfer devices can be any suitable conventional equipment, and their integration in the present printing system will be clear to the person skilled in the art without the need for more detailed description. In the process according to the present invention the particles comprising at least 50% of flaky metallic substrate, but preferably 75% of the particles comprise a flaky metallic substrate, more preferably at least 85% and most preferably 95 to 100% of the particles comprise a flaky metallic substrate.

In a further embodiment, the flaky metallic substrate has preferably an average (median) thickness (h₅₀ value) in the range of 10 to 500 nm, more preferably in a range of 15 to 100 nm and most preferably in a range of 20 to 40 nm. Especially with very thin metal pigments, especially aluminum pigments (h₅₀=15 to 40 nm) very good transfer of the metallic particles to the donor surface and to the substrate was reached.

In general, the thickness of the metal or metallic particles can be determined with the aid of a scanning electron microscope (SEM). For this purpose, the particles are incorporated in a concentration of about 10 wt.-% into a two-component clearcoat, e.g. Autoclear Plus HS from Sikkens GmbH, with a sleeved brush, applied to a film with the aid of a spiral applicator (wet film thickness 26 μm) and dried. After a drying time of 24 h, transverse sections of these applicator drawdowns were produced. The transverse sections were analyzed by SEM (Zeiss supra 35) using the SE (secondary electrons) detector. For a valuable analysis of platelet particles, these should be well oriented plane-parallel to the substrate to minimize the systematic error of the angle of inclination caused by misaligned flakes.

Here, a sufficient number of particles should be measured so as to provide a representative mean value. Customarily, approximately 50 to 100 particles are measured. The h₅₀ value is the median value of the particle thickness distribution measured using this method. This h₅₀-value can be used as a measure of the average thickness.

A detailed procedure of the determination of the thickness distribution and the h₅₀-values of the metal or metallic particles is also described in EP 1613702B1.

In one of the embodiments of the process according to the present invention the flaky metallic substrate has an aspect ratio in the range from 1500:1 to 10:1, preferably 1000:1 to 50:1 and more preferably 800:1 to 100:1 wherein the aspect ratio is defined as the ratio between the average pigment diameter (D₅₀ value) and the average pigment thickness (h₅₀ value).

The pigment size is typically indicated using D values which denote to quantile values of the volume averaged particle size distribution in frequency representation. Here, the number indicates the percentage of particles smaller than a specified size contained in a volume-averaged particle size distribution. For example, the D₅₀ value indicates the size that is equal or smaller than 50% of the particles. These measurements are conducted e.g. by means of laser granulometry using a particle size analyzer manufactured by Sympatec GmbH (model: Helos/BR). The measurement is conducted according to data from the manufacturer.

In one of the embodiments of the process according to the present invention the flaky metallic substrate is selected from aluminum, copper, zinc, gold-bronze, chromium, titanium, zirconium, tin, iron and steel flaky substrates or pigments of alloys of these metals. In a preferred embodiment the flaky metal substrate is aluminum, gold-bronze or copper and in a most preferred embodiment the flaky metal substrate is aluminum.

The metallic substrate may on its surface also contain up to 30 wt. % of an oxide, a hydroxide, an oxide hydrate or a mixture thereof of the same metal. So, an aluminum substrate may contain up to 30 wt. % of aluminum oxide.

Such metal oxide layers are typically natural oxides formed on a metallic substrate under ambient condition or under the conditions of metal flake manufacturing, e.g. in a milling process. The modification substances in such cases are bounded to such natural metal oxide.

The metallic substrate may be manufactured by milling processes or by PVD processes (Physical Vapor Deposition). More preferred are flaky metallic substrate made by a PVD process and most preferably such flaky metallic substrate is an aluminum pigment.

According to preferred embodiments the flaky substrate are surface modified by using modification substances which are at least one of the following:
i) [R—O]₍ₙ₋ₒ₋ₚ₎P(O)(OR¹)ₒ(OR²)ₚ
with o=1-2, p=0-2 and n+o+p=3 or 2,
or
ii) R₍ₙ₋ₒ₋ₚ₎—P(O)(OR¹)ₒ(OR²)ₚ and n+o+p=3
or
iii) R—P(OR¹)(OR²)
or
iv) R′—SiX₃.

Herein X stands for a hydrolysable group like halide or alkoxy (OR³) with R³=methyl, ethyl, n-propyl, isopropyl, n-butyl, isobutyl, n-pentyl. Preferably R³ is methyl or ethyl. X can also be a hydroxy group OH. The moieties R¹ and R² are independently H, a metal ion or linear or branched alkyl moieties with 1 to 4 C-atoms, preferably H. R or R′ are independently linear or branched alkyl, aryl, alkylaryl or arylalkyl moieties with 1 to 24 C-atoms, preferably with 6 to 20 C-atoms and most preferably with 8 to 18 C-atoms. Preferred are alkyl moieties. These alkyl or aryl moieties can be further functionalized by a functional group. Such functional group can introduce polar groups which can interact specifically with the surface of the substrate and/or donor surfaces.

For formulas i) the sum of n, p and o is preferably 3.

Preferably the functional group of moieties R or R′ independently are phosphonic, phosphate, amino, epoxy, acrylate, methacrylate, hydroxy, mercapto, thiol, cyano, isocyanate, carboxy, carbamate, ureido or thioureido groups.

In some embodiments the functional group are of the same kind as the group which bonds to the metal pigment surface. Preferred herein are additives such as α,ω-diphosphonic acids or α,ω-diphosphoric acid ester.

The n, o and p are stochiometric factors. They usually denote to molecular species and the phosphoric esters of species i) can be mixtures of mono- or diesters. In preferred embodiments the alkyl moieties R are alkyl groups with 8 to 18 C-atoms. Most preferred are embodiments wherein R¹ is H with p=0 and the averaged o=0.8 to 1.8, more preferably averaged o=1.0 to 1.7.

With “averaged o” the average over a distribution of different species (mono- and di-esters) regarding the stochiometric factor o is meant. Preferred embodiments of species i) are phosphoric acid isotridecyl ester or cetyl phosphate.

For species ii) it is preferred that p+o=2 (monophosphonates). Preferred embodiments of species ii) are octyl posphonic acid (OPS) or lauryl phosphonic acid.

Suitable organofunctional silanes according to iv) are, for example, many representatives produced by Evonik and products sold under the trade name “Dynasylan”. Such organofunctional silanes may form covalent bonds or hydrogen bonds or just Van-der-Waals forces with the surface of the donor substrate or with the receptive layer on the substrate. For example, 3-methacryloxypropyl trimethoxysilane (Dynasylan MEMO), vinyl tri(m)ethoxysilane (Dynasylan VTMO or VTEO), aminopropyl trimethoxysilane (Dynasylan AMMO), aminopropyl triethoxysilane (Dynasylan AMEO) or N2-aminoethyl-3-aminopropyl trimethoxysilane (Dynasylan DAMO) or 3-glycidoxypropyl trimethoxysilane (Dynasylan GLYMO) can be used herein.

Other examples of silanes are: isocyanato triethoxy silane, 3-isocyanatopropoxyl triethoxy silane, vinyl triacetoxy silane, vinyl trichlorosilane, 3-methacryloxypropyl triethoxy silane, methacryloxy propyl trimethoxy silane, 3-acryloxypropyl trimethoxy silane, 2-methacryloxyethyl tri-(m)ethoxy silane, 2-acryloxyethyl tri(m)ethoxy silane, 3-methacryloxypropyl tris(methoxy-ethoxy)silane, 3-methacryloxypropyl tris(butoxyethoxy)silane, 3-methacryloxypropyl tris(propoxy)silane or 3-methacryloxypropyl tris(butoxy)silane.

Instead of such functional silanes or in addition to these also unipolar organofunctional silanes may be used with the formula
v) R″_{z}SiX_{(4-z)} or
vi) R′R″SiX₂

In formula v), z is an integer from 2 to 3, R″ in formula v) or vi) is an unsubstituted, unbranched or branched alkyl chain having 1 to 24 C atoms or an aryl group having 6 to 18 C atoms or an arylalkyl or alkylaryl group having 7 to 25 C atoms or mixtures thereof, and X is a halogen group and/or preferably an alkoxy group. The R″ moieties can be the same or independently different moieties. Preference is given to alkyl silanes having alkyl chains in a range of 4 to 18 C atoms or to aryl silanes having phenyl groups. R″ may also be joined cyclically to Si, in which case z is typically 2. X is most preferably ethoxy or methoxy.

Mixtures of organofunctional silanes with different z-values may also be employed.

Preferred examples of such unpolar organofunctional silanes are alkyl or aryl silanes. Examples for these silanes are butyltrimethoxysilane, butyltriethoxysilane, octyltrimethoxysilane, octyltriethoxysilane, decyltrimethoxysilane, decyltrimethoxysilane, hexadecyltrimethoxysilane, hexadecyltriethoxysilane, phenyltrimethoxysilane, phenyltriethoxysilane and mixtures thereof.

Examples of silanes according to formulas v) or vi) are vinyl ethyl dichlorosilane, vinyl methyl dichlorosilane, vinyl methyl diacetoxy silane, vinyl methyl diethoxy silane, phenyl vinyl diethoxy silane, phenyl allyl diethoxy silane and phenyl allyl dichlorosilane.

In preferred embodiments mixtures of silanes of formula iv) and of formula v) are used. Especially preferred are mixtures of amino- with alkyl silanes.

In further embodiments vii) the additive is an organofunctional silane which is a pre-condensated heteropolysiloxane. This pre-condensated heteropolysiloxane preferably contains at least one aminosilane and at least one alkylsilane. Preferred pre-condensated heteropolysiloxanes can be obtained from Evonik Industries AG, 45128 Essen, Germany, under the brand names Dynasylan Hydrosil 2627, Dynasylan Hydrosil 2776, Dynasylan Hydrosil 2909, Dynasylan 1146, and Dynasylan Hydrosil 2907. Particularly preferred water-based heteropolysiloxanes are Dynasylan Hydrosil 2627, Dynasylan Hydrosil 2776, Dynasylan Hydrosil 2907, and Dynasylan Hydrosil 2909.

According to a preferred variant of the invention, the precondensed heteropolysiloxane is selected from the group composed of Dynasylan Hydrosil 2627, Dynasylan Hydrosil 2776, Dynasylan Hydrosil 2909, Dynasylan 1146, Dynasylan Hydrosil 2907, and mixtures thereof.

Preferred are additives of types i) to v) and specially preferred are additives of type ii).

The additives can impart a sufficient corrosion stability to the flaky metal pigments to survive the aqueous media of the coating station before the particles are transferred to the donor surface. Flaky metal pigments produced by milling technology are coated with fatty acids and these additives are not sufficient for enabling corrosion stability over longer time with these effect pigments. Therefore, the gloss retention with these pigments in the printing method is not sufficient. As the donor surface is usually quite hydrophobic the additives may also impart a sufficient hydrophobicity to the surface of the flaky metallic pigments. On the other hand the additive may be chosen in such way to additionally have functional groups which are quite compatible with the chemistry of the receptive layer and thus enable a good transfer to the part of the substrate which has been coated by the adhesive or receptive layer.

The particles used in the method according to the present invention are produced by dispersing the initial metallic particles in an organic solvent, optionally heating to a temperature of about 20 to the boiling point of the particulate solvent used ° C. and more preferably from 40 to 80° C. and mixing with a solution of an additive in a small but suitable amount of organic solvent.

Especially for metal pigments obtained by milling the filter cake obtained can be dried in a vacuum at about 60°−130° C. and then a different solvent may be added. For some surface-modifying agents it is not necessary to heat the mixture, for these materials simple mixing can be sufficient.

For the mixing step common mixing aggregates for metal effect pigments like a planetary mixer or a kneader can be used.

In further embodiments the metal pigment surface can be additionally modified by a dispersing additive. The dispersing additive is preferably suitable for aqueous systems.

The dispersing agent can be used without restriction, so long as the dispersing agent can be used in a pigment ink, and examples include cationic dispersing agents, anionic dispersing agents, nonionic dispersing agents and surfactants and the like.

Examples of anionic dispersing agents include polyacrylic acid, poly methacrylic acid, acrylic acid-acrylonitrile copolymer, vinylacetate-acrylic acid ester copolymer, acrylic acid-alkyl acrylate ester copolymer, styrene-acrylic acid copolymer, styrene-methacrylic acid copolymer, styrene-acrylic acid-alkyl acrylate ester copolymer, styrene-methacrylic acid-alkyl acrylate ester copolymer, styrene-α-methylstyrene-acrylic acid copolymer, styrene-α-methylstyrene-acrylic acid-alkyl acrylate ester copolymer, styrene-maleic acid copolymer, vinylnaphthalene-maleic acid copolymer, vinylacetate-ethylene copolymer, vinylacetate-fatty acid vinylethylene copolymer, vinylacetate-maleic acid ester copolymer, vinylacetate-crotonic acid copolymer, and vinylacetate-acrylic acid copolymer and the like. Examples of nonionic dispersing agents include polyvinyl pyrrolidone, polypropylene glycol, and vinylpyrrolidone-vinylacetate copolymer, and the like. Examples of surfactant as dispersing agents include anionic surfactants such as sodium dodecylbenzene sulfonate, sodium laurate, and ammonium salts of polyoxyethylene alkyl ether sulfate; and nonionic surfactants such as polyoxyethylene alkyl ether, polyoxyethylene alkyl ester, polyoxyethylene sorbitan fatty acid ester, polyoxyethylene alkylphenyl ether, polyoxyethylene alkylamine, and polyoxyethylene alkylamide, and the like.

Example for dispersing additives are_Disperbyk 118, Disperbyk 180, Disperbyk 181, Disperbyk 182, Disperbyk 184, Disperbyk 185, Disperbyk 187, Disperbyk 190, Disperbyk 191, Disperbyk 192, Disperbyk193, Disperbyk 194-N, Disperbyk 199, Disperbyk 2010, Disperbyk 2012, Disperbyk 2013, Disperbyk 2014, Disperbyk 2015 Disperbyk 2018, Disperbyk 2019, Disperbyk 2022, Disperbyk 2023, Disperbyk 2055, Disperbyk 2059, Disperbyk 2060, Disperbyk 2061, Disperbyk 2062, Disperbyk 2080 and Disperbyk 2081, all produced by Byk-Gardener, Additives, Wesel, Germany.

### The Donor Surface

The donor surface of the printing process in preferred embodiments is a hydrophobic surface, made typically of an elastomer that can be tailored to have properties as herein disclosed, generally prepared from a silicone-based material. Poly (dimethyl-siloxane) polymers, which are silicone-based, have been found suitable. In one embodiment, a fluid curable composition was formulated by combining three silicone-based polymers: a vinyl-terminated polydimethylsiloxane 5000 cSt (DMS V35, Gelest®, CAS No. 68083-19-2) in an amount of about 44.8% by weight of the total composition (wt. %), a vinyl functional polydimethyl siloxane containing both terminal and pendant vinyl groups (Polymer XP RV 5000, Evonik® Hanse, CAS No. 68083-18-1) in an amount of about 19.2 wt. %, and a branched structure vinyl functional polydimethyl siloxane (VQM Resin-146, Gelest®, CAS No. 68584-83-8) in an amount of about 25.6 wt. %. To the mixture of the vinyl functional polydimethyl siloxanes were added: a platinum catalyst, such as a platinum divinyltetramethyldisiloxane complex (SIP 6831.2, Gelest®, CAS No. 68478-92-2) in an amount of about 0.1 wt. %, an inhibitor to better control curing conditions, Inhibitor 600 of Evonik® Hanse, in an amount of about 2.6 wt. %, and finally a reactive cross-linker, such as a methyl-hydrosiloxane-dimethylsiloxane copolymer (HMS 301, Gelest®, CAS No. 68037-59-2) in an amount of about 7.7 wt. %, which initiates the addition curing. This addition curable composition was shortly thereafter applied with a smooth leveling knife upon the support of the donor surface (e.g. an epoxy sleeve mountable on drum 10), such support being optionally treated (e.g. by corona or with a priming substance) to further the adherence of the donor surface material to its support. The applied fluid was cured for two hours at 100-120° C. in a ventilated oven so as to form a donor surface.

The hydrophobicity is to enable the particles exposed to selective stripping by the tacky film created on the receptive layer bearing substrate to transfer cleanly to the substrate without splitting.

The donor surface should be hydrophobic, that is to say the wetting angle with the aqueous carrier of the particles should exceed 90°. The wetting angle is the angle formed by the meniscus at the liquid/air/solid interface and if it exceeds 90°, the water tends to bead and does not wet, and therefore adhere, to the surface. The wetting angle or equilibrium contact angle Θ₀, which is comprised between and can be calculated from the receding (minimal) contact angle Θᵣ and the advancing (maximal) contact angle Θ_{A}, can be assessed at a given temperature and pressure of relevance to the operational conditions of the process. It is conventionally measured with a goniometer or a drop shape analyzer through a drop of liquid having a volume of 5 μl, where the liquid-vapor interface meets the solid polymeric surface, at ambient temperature (circa 23° C.) and pressure (circa 100 kPa). Contact angle measurements can for instance be performed with a Contact Angle analyzer—Krüss™; “Easy Drop” FM40Mk2 using distilled water as reference liquid.

This hydrophobicity may be an inherent property of the polymer forming the donor surface or may be enhanced by inclusion of hydrophobicity additives in the polymer composition. Additives that may promote the hydrophobicity of a polymeric composition may be, for example, oils (e.g., synthetic, natural, plant or mineral oils), waxes, plasticizers and silicone additives. Such hydrophobicity additives can be compatible with any polymeric material, as long as their respective chemical nature or amounts do not prevent proper formation of the donor surface, and for instance would not impair adequate curing of the polymeric material.

The roughness or finish of the donor surface will be replicated in the printed metallized surface. Therefore if a mirror finish or highly glossy appearance is required, the donor surface would need to be smoother than if a matte or satin look is desired. These visual effects can also be derived from the roughness of the printing substrate and/or of the receptive layer.

The donor surface in the drawings is the outer surface of a drum but this is not essential as it may alternatively be the surface of an endless transfer member having the form of a belt guided over guide rollers and maintained under an appropriate tension at least while it is passing through the coating apparatus. Additional architectures may allow the donor surface and the coating station to be in relative movement one with the other. For instance, the donor surface may form a movable plan which can repeatedly pass beneath a static coating station, or form a static plan, the coating station repeatedly moving from one edge of the plan to the other so as to entirely cover the donor surface with particles. Conceivably, both the donor surface and the coating station may be moving with respect to one another and with respect to a static point in space so as to reduce the time it may take to achieve entire coating of the donor surface with the particles dispensed by the coating station. All such forms of donor surfaces can be said to be movable (e.g. rotatably, cyclically, endlessly, repeatedly movable or the like) with respect to the coating station where any such passing donor surface can be coated with particles (or replenished with particles in exposed regions).

The donor surface may additionally address practical or particular considerations resulting from the specific architecture of the printing system. For instance, it can be flexible enough to be mounted on a drum, have sufficient abrasion resistance, be inert to the particles and/or fluids being employed, and/or be resistant to any operating condition of relevance (e.g. pressure, heat, tension, etc.). Fulfilling any such property tends to favorably increase the lifespan of the donor surface.

The donor surface, whether formed as a sleeve over a drum or a belt over guide rollers, may further comprise, on the side opposite the particle receiving outer layer, a body, which together with the donor surface may be referred to as a transfer member. The body may comprise different layers each providing to the overall transfer member one or more desired property selected, for instance, from mechanical resistivity, thermal conductivity, compressibility (e.g., to improve “macroscopic” contact between the donor surface and the impression cylinder), conformability (e.g. to improve “microscopic” contact between the donor surface and the printing substrate on the impression cylinder) and any such characteristic readily understood by persons skilled in the art of printing transfer members.

A further embodiment of this invention is directed to the use of particles, wherein at least 50 wt. % of the particles are flaky metal pigments comprising a flaky metallic substrate and a surface modification layer of the metallic substrate, wherein the surface modification layer has been made by a treatment of the metallic substrate surface by at least one of the modification substances from the group consisting of phosphoric esters, phosphonic esters, phosphonic acids, phosphinate esters, organofunctional silanes, organofunctional titanates, organofunctional zirconates, organofunctional aluminates and mixtures thereof in a method of printing onto a surface of a substrate, which method comprises
a. Providing a donor surface
b. Passing the donor surface through a coating station from which the donor surface exits coated with up to a monolayer of individual particles, and
c. Repeatedly performing the steps of
   i. Treating the surface of the substrate to render the affinity of the particles to at least selected regions of the surface of the substrate greater than the affinity of the particles to the donor surface,
   ii. Contacting the surface of the substrate with the donor surface to cause particles to transfer from the donor surface only to the treated selected regions of the surface of the substrate, thereby exposing regions of the donor surface from which particles are transferred to the corresponding regions on the substrate, and
   iii. Thereby generating a plurality of individual particles adhered to the treated surface of the substrate

Returning the donor surface to the coating station to render the particle monolayer continuous in order to permit printing of a subsequent image on the surface of the substrate.

All features, embodiments and preferred embodiments of the method of printing disclosed in this invention likewise apply to the use of particles in the printing method as mentioned above.

### EXAMPLES

Example 1a: A certain defined amount of aluminum flake paste (VP-68680/G IL, Eckart GmbH) were homogenized in a kneader. VP-68680/G IL is an aluminum effect pigment with a median thickness of about 24 nm and a d₅₀ of about 2.5 μm produced by milling processes. The additive Hostaphat CC100 was dissolved in isopropanol. From this solution an amount was added to the aluminum paste in the kneader so that in total 2.0 wt % of the additive were added, referred to the amount of aluminum flake. The mixture was homogenized for further 5 min and isopropanol was added to fix the total amount of solids to 65 wt %.

Example 1b: Like Example 1 but additionally to the 2.0 wt % of Hostaphat CC100 also 2.0 wt % of Disperbyk 192 were added a dispersing additive (each with reference to the al flake content).

Example 1c: Like Example 1 but 3.0 wt % of Hostaphat CC100 were added a dispersing additive (with reference to the Al flake content).

Comp. Example 1: VP-68680/G IL without additive treatment.

Example 2a: Al: Metalure A-31510 EN+3% Hostaphat CC 100 Lab mixer (PVD-pigment)

Like Example 1a, but a lab mixer was used as aggregate, as aluminum flake paste a dispersion of commercially available PVD aluminum effect pigments in ethyl acetate (Metalure® A-41010 AE, 10 wt. % aluminum content; d₅₀=10 μm, Eckart America) and as additive 3.0 wt. % referring to the metal content of the aluminum effect pigment of cetyl phosphate ester (Hostaphat CC 100) were used. The final content of the solid amount of the dispersion in ethyl acetate was 10 wt. %.

Example 2b: Like Example 2a but additionally 3.0 wt % dispersion additive Disperbyk® 192 were added with the additive.

Example 2c: Like Example 2a, but as additive 3.0 wt % lauryl phosphate monoester were used (Fisher Scientific 11332727).

Example 2d: Like Example 2c but additionally 3.0 wt % dispersion additive Disperbyk 192 were added with the additive.

Comparative Example 2: Metalure A-41010 AE (10% aluminum content) without additive treatment.

Example 3a: Like Example 1a, but a laboratory mixer was used as mixing aggregate and as aluminum flake paste a filter cake of VP-66762/G IL (Eckart GmbH) and as additive 2.0 wt. % OPS were used. The final content of the solid amount of the paste was 25 wt. %. VP-66762/G IL is a very thin aluminum effect pigment produced by milling processes with a median thickness of about 35 nm and a d₅₀ of about 9 μm.

Example 3b: Like Example 3a but additionally 2.0 wt % Disperbyk 192 were added with the additive (2.0 wt % OPS).

Example 3c: (D32): Al: VP-66762/G IL FK+2% Hostaphat CC 100, Lab mixer Like Example 3a as additive 2.0 wt % Hostaphat CC 100 were used.

Comparative Example 3: VP-66762/G IL without additive treatment.

Comparative Example 4: 35.49 pbw of a non-leafing aluminium pigment made

by vacuum metallisation, dispersed in isopropanol, solid content 20 wt. %, average particle thickness 30-45 nm, particle size distribution (d10/d50/d90): 4 μm/7.9 μm/15.5 μm and 43.09 pbw of isopropanol were intimately mixed until a dispersion was obtained. 0.02 pbw of a peroxo molybdic acid solution (obtained by mixing 1 pbw of molybdic acid with 3 pbw of a 30% hydrogenperoxide solution) was added and the mixing was continued. Then, the dispersion was heated to 80° C. and 3.71 pbw of tetraethoxysilane (TEOS), 5.20 pbw of water, and 0.56 pbw of acetic acid were added. This mixture was stirred for some time while the temperature was kept at 80° C.

At time intervals, 0.28 pbw of ethylenediamine and 3.55 pbw of isopropanol were added while being stirred at 80° C. until in total 0.84 pbw of ethylenediamine was added. The stirring at 80° C. was continued for a couple of hours. Thereafter the mixture was cooled, part of the solvent was removed and a paste of encapsulated aluminium particles was obtained.

The pastes of aluminum particles obtained in each of the examples 1-3 were dispersed in water and applied to a substrate using the process described in WO2016/189515 A9.

As comparative examples pastes of aluminum flake of the respective metal pigments without additive treatment were used. They were dispersed in water and applied to a substrate using the printing process described in WO 2016/189515 A9.

TABLE 1
Results of Printing

| Sample | Printability | Gloss 20° | OD | Gloss retention |
|---|---|---|---|---|
| Ex. 1a | good | 405 | 0.88 | very good |
| Ex. 1b | good | 340 | 0.83 | very good |
| Ex. 1c | good | 362 | 0.94 | very good |
| Comp. | fair | 277 | 0.53 | failed |
| Ex. 1 | | | | |
| Ex. 2a | Good | 600 | 0.95 | very good |
| Ex. 2b | Good | 570 | 0.91 | very good |
| Ex. 2c | Good | 590 | 0.93 | very good |
| Ex. 2d | Good | 610 | 0.94 | very good |
| Comp. | Failed (donor | — | — | failed |
| Ex. 2 | surface) | | | |
| Ex. 3a | fair | 205 | 0.41 | very good |
| Ex. 3b | Good | 228 | 0.53 | very good |
| Ex. 3c | Good | 226 | 0.74 | very good |
| Comp. | average | 201 | 0.47 | failed |
| Ex. 3 | | | | |
| Comp. | Failed (donor | — | — | failed |
| Example | surface) | | | |
| 4 | | | | |

The transfer of the metal pigments to the donor surface and also the printability onto the substrate was evaluated. The gloss, optical density, gloss retention and corrosion stability of the thus prepared samples were measured. The results are shown in table 1.

With gloss retention it is meant to measure the gloss after the printing procedure has been cyclically conducted for a while. For example, the gloss after one day, two days and finally up to 30 days after printing was measured. When the gloss after 30 days was not lower than 95% of the initial gloss the gloss retention was marked “very good”. If the gloss was lower after 30 days was not lower than 90% of the initial gloss the gloss retention was marked “very good”.

The gloss retention was marked as “failed” if the gloss was lower than 50% of the initial gloss.

### Gloss Measurement:

The gloss of the metallized surface of printed samples was measured using a glossmeter (device: micro-TRI-gloss manufactured by BYK-Gardner GmbH, D-82538 Geretsried, Germany). Since the measured surfaces are highly reflective, the measurement was performed using a 20° angle setting. For each sample five measurements in different areas were performed and the values were arithmetically averaged.

### Optical Density (OD) Measurement:

The optical density provides an indication of the amount of transferred metallic pigments. To determine the optical density a black/white transmission densitometer (device: 341C manufactured by X-Rite Inc., Grand Rapids MI 49512, USA) was used. To calibrate the pure substrate was first measured and the value set to zero. For each sample three measurements in different areas were performed and the values were arithmetically averaged. An OD of below 0.40 was not a satisfying transfer of the metallic pigments.

The samples prepared with the aluminum particles of examples 1-3 all showed a high initial gloss level, a good gloss retention and a good corrosion stability. Especially the coated metal effect pigments according to Examples 2 (PVD pigments) exhibited a high average gloss of about 600 gloss units measured at 20°. The substrates printed with the comparative examples 1 and 2 showed a high to fair initial gloss level, but the gloss retention was poor as this sample showed corrosion in the aqueous media within about two days after application. Furthermore, the OD values were usually lower compared to the respective inventive examples indicating a less good transfer to the substrate.

In contrast to other inventive Examples and to Comparative Examples 1 and 3 the effect pigments of Comparative Example 2 and of Comparative Example 4 were not transferred in sufficient amount to the donor surface and hence the printing result to the substrate was not satisfactory.

1. A method of printing onto a surface of a substrate, which method comprises
a. Providing a donor surface
b. Passing the donor surface through a coating station from which the donor surface exits coated with individual particles, and
c. Repeatedly performing the steps of
i. Treating the surface of the substrate to render the affinity of the particles to at least selected regions of the surface of the substrate greater than the affinity of the particles to the donor surface, wherein a receptive and/or adhesive layer is applied onto the substrate,
ii. Contacting the surface of the substrate with the donor surface to cause particles to transfer from the donor surface only to the treated selected regions of the surface of the substrate, thereby exposing regions of the donor surface from which particles are transferred to the corresponding regions on the substrate, and
iii. Thereby generating a plurality of individual particles adhered to the treated surface of the substrate,
iv. Returning the donor surface to the coating station to render the particle monolayer continuous in order to permit printing of a subsequent image on the surface of the substrate,
characterised in that at least 50 wt. % of the individual particles are flaky metal pigments comprising a flaky metallic substrate and a surface modification layer of the metallic substrate, wherein the surface modification has been made by a treatment of the metallic substrate surface by at least one of the modification substances from the group consisting of phosphate ester, phosphonic esters, phosphonic acids, phosphinate esters, organofunctional silanes, organofunctional titanates, organofunctional zirconates, organofunctional aluminates and mixtures thereof.

2. The method of claim 1, wherein in step b the donor surface exists the coating station coated with a monolayer of individual particles.

3. The method of claim 1, wherein the flaky metallic substrate has an average thickness (h₅₀ value) in the range of 10 to 500 nm and preferably 15 to 40 nm.

4. The method of claim 1, wherein the flaky metallic substrate has an aspect ratio in the range from 1500:1 to 10:1, wherein the aspect ratio is defined as the ratio between the average pigment diameter (D₅₀ value) and the average (median) pigment thickness (h₅₀ value).

5. The method of claim 1, wherein the flaky metallic substrate is selected from aluminum, copper, zinc, gold-bronze, chromium, titanium, zirconium, tin, iron and steel flaky substrates or pigments of alloys of these metals.

6. The method of claim 1, wherein the flaky metallic substrate is made by a PVD process and preferably is an aluminum pigment.

7. The method of claim 1, wherein the flaky metallic substrate on its surface also contains up to 30 wt. % of an oxide, a hydroxide, an oxide hydrate or a mixture thereof of the same metal and the modification substance is bound on this metal oxide.

8. The method of claim 1, wherein the modification substances is at least one of the following:
i) [R—O]₍ₙ₋ₒ₋ₚ₎P(O)(OR¹)ₒ(OR²)ₚ
with o=1-2, p=0-2 and n+o+p=3 or 2
ii) R₍ₙ₋ₒ₋ₚ₎P(O)(OR¹)ₒ(OR²)ₚ and n+o+p=3
iii) R—P(OR¹)(OR²)
iv) R′—SiX₃
with X=halide, OH or alkoxy (OR³) with R³=methyl, ethyl, n-propyl, isopropyl, n-butyl, isobutyl, n-pentyl and wherein R¹, R² are H, a metal ion or linear or branched alkyl moieties with 1 to 4 C-atoms, and R or R′ are linear or branched alkyl, aryl, alkylaryl or arylalkyl moieties with 1 to 24 C-atoms, which can be further functionalized by a functional group,
v) R″_{z}SiX_{(4-z)}
vi) R′R″SiX₂
wherein in formula v), z is an integer from 1 to 3, R″ in formulas v) or vi) is an unsubstituted, unbranched or branched alkyl chain having 1 to 24 C atoms or an aryl group having 6 to 18 C atoms or an arylalkyl or alkylaryl group having 7 to 25 C atoms or mixtures thereof, and X is a halogen group and/or preferably an alkoxy group, or
vii) pre-condensated polyheterosiloxanes.

9. The method of claim 8, wherein the functional group of moieties R or R′ independently are selected from the group consisting of phosphonic, phosphate, amino, epoxy, acrylate, methacrylate, hydroxy, mercapto, thiol, cyano, isocyanate, carboxy, carbamate, ureido or thioureido.

10. The method of claim 8, wherein the additives are α,ω-diphosphonic acids or α,ω-diphosphoric acid ester.

11. The method of claim 1, wherein the metal pigment surface can be additionally modified by a dispersing additive.

12. The method of claim 1, wherein the donor surface is a hydrophobic surface.

13. (canceled)

14. (canceled)

15. The method of claim 12, wherein the hydrophobic surface is made by an elastomer prepared from poly (dimethylsiloxane) polymers.

16. The product made by the process of claim 1.

17. The product made by the process of claim 8.

18. The product made by the process of claim 12.
